(19) United States
(12) Patent Application Publication
(10) Pub. No.: US 2005/0190743 A1
(43) Pub. Date: Sep. 1, 2005

(54) Telecommunications gateway

(75) Inventors: Matia Marcu, Natanya (IL); Michael Rabinovich, Modiin (IL); Joshua Klipper, Netanya (IL)

Correspondence Address: Fogg and Associates, LLC, P.O. Box 581339, Minneapolis, MN, 55458-1339, US

(73) Assignee: ADC Telecommunications Israel Ltd.

(21) Appl. No.: 10/763,677

(22) Filed: Jan. 22, 2004

(51) Int. Cl. H04L 12/66

(52) U.S. Cl. 370/352; 370/466

(57) ABSTRACT

A telecommunications gateway enables the conversion of signaling information from one protocol to another. The telecommunications gateway is in communication with a plurality of costumer equipment devices having different customer protocols. The telecommunications gateway is also in communication with a plurality of service provider equipment devices having different service provider protocols. The telecommunications gateway comprises a plurality of protocol handlers, wherein each protocol handler is associated with a given customer protocol or service provider protocol, and a plurality of operation modules in communication with each of the protocol handlers. Each of the protocol handlers is configured to convert input signals in conformance with the associated protocol to a generic information format. In addition, each of the protocol handlers is configured to convert information from the generic information format to output signals in conformance with the associated protocol. Each of the operation modules is configured to perform a telecommunications operation using information in the generic information format.

### TECHNICAL FIELD

The present invention relates generally to the field of telecommunications and, in particular, to systems and methods for managing data transmissions over telecommunications networks.

### BACKGROUND

In many telecommunications systems, data is transmitted over telecommunications networks in accordance with predetermined standards, or protocols. Each protocol typically includes a unique command set, as well as a set of rules or conventions for segmenting and transmitting data. In some circumstances, it can be desirable to transmit data between telecommunications systems having different protocols. In these circumstances, it is often necessary to convert commands and data from one protocol to another.

This protocol conversion process can be carried out by a telecommunications gateway, which provides an interface between customer equipment devices and service provider equipment devices. Existing protocol conversion schemes are unnecessarily complex and non-intuitive. Accordingly, there is a need for a simpler, more efficient approach to the protocol conversion process within telecommunications gateways.

### SUMMARY OF THE INVENTION

The above-mentioned drawbacks associated with traditional protocol conversion systems and methods are addressed by embodiments of the present invention and will be understood by reading and studying the following specification.

In one embodiment, a method for converting telecommunications data from a first protocol to a second protocol comprises receiving input signals in conformance with the first protocol and mapping the input signals to an abstract, protocol-independent information format. The method further comprises converting information from the abstract, protocol-independent information format to protocol-specific output signals, and transmitting the output signals in conformance with the second protocol.

In another embodiment, a telecommunications gateway is in communication with a plurality of costumer equipment devices having different customer protocols and with a plurality of service provider equipment devices having different service provider protocols. The telecommunications gateway comprises a plurality of protocol handlers. Each protocol handler is associated with a given customer protocol or service provider protocol. The telecommunications gateway further comprises a plurality of operation modules in communication with each of the protocol handlers. Each of the protocol handlers is configured to convert input signals in conformance with the associated protocol to a generic information format. Each of the protocol handlers is further configured to convert information from the generic information format to output signals in conformance with the associated protocol. In addition, each of the operation modules is configured to perform a telecommunications operation using information in the generic information format.

Other embodiments are described and claimed.

### BRIEF DESCRIPTION OF THE DRAWINGS

FIG. 1 is a block diagram of one embodiment of a telecommunications system.

FIG. 2 illustrates a conventional telecommunications gateway.

FIG. 3 illustrates a telecommunications gateway in accordance with one embodiment of the present invention.

FIG. 4 is a flow chart illustrating the basic operation of the telecommunications gateway shown in FIG. 3.

### DETAILED DESCRIPTION OF THE PREFERRED EMBODIMENT

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

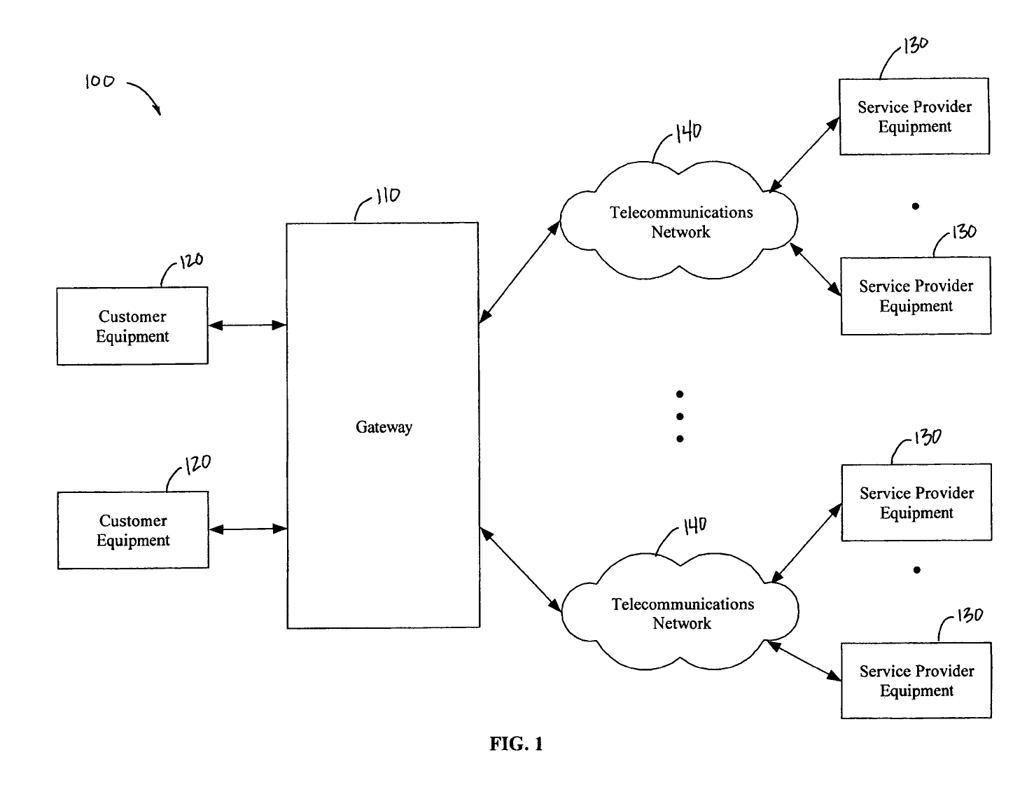

FIG. 1 is a block diagram of one embodiment of a telecommunications system 100. In the embodiment illustrated in FIG. 1, the telecommunications system 100 comprises a gateway 110 in communication with customer equipment 120. The customer equipment 120 may comprise a wide variety of devices, such as, for example, a plain old telephone system (POTS), an integrated services digital network (ISDN) phone, a private branch exchange (PBX), an integrated access device (IAD), and an Internet protocol (IP) phone, to name a few.

The gateway 110 is also in communication with service provider equipment 130 through one or more telecommunications networks 140, such as, for example, an IP network or a public switched telephone network (PSTN). The service provider equipment 130 may also comprise a wide variety of devices, depending on the associated telecommunications network 140. For example, if a first telecommunications network 140 comprises a PSTN, then the service provider equipment 130 in communication with the gateway 110 through the first telecommunications network 140 may comprise a central office (CO), a PBX, and the like. If a second telecommunications network 140 comprises an IP network such as the Internet, then the service provider equipment 130 in communication with the gateway 110 through the second telecommunications network 140 may comprise a voice over IP (VoIP) controller, a PBX with IP trunks, and the like.

In operation, data is typically transmitted over the telecommunications system 100 by forming communication links between pairs of customer equipment 120 and service provider equipment 130 through the gateway 110 and the appropriate telecommunications network 140. Each communication link typically has an associated gateway interface, signaling protocol, and voice format. For example, in one embodiment, the selected customer equipment 120 comprises a POTS or a PBX, the selected service provider equipment 130 comprises a CO, and the corresponding communication link comprises an analog interface, loop start signal protocol, and analog voice format. In another embodiment, the selected customer equipment 120 comprises an ISDN phone or a PBX, and the corresponding communication link comprises an ISDN basic/primary rate access interface (BRI/PRI), Q.931 signaling protocol, and pulse code modulation (PCM) voice format. In another embodiment, the selected customer equipment 120 comprises a PBX, the selected service provider equipment 130 comprises a CO or a PBX, and the corresponding communication link comprises an ISDN PRI interface, QSIG signaling protocol, and PCM voice format. In another embodiment, the selected customer equipment 120 comprises an IAD, and the corresponding communication link comprises a digital subscriber line (xDSL) interface, voice over asynchronous transfer mode (VoATM) protocol, and ATM adaptation layer 2 (AAL2) voice format. In another embodiment, the selected customer equipment 120 comprises an IP phone, the selected service provider equipment 130 comprises a PBX with IP trunks, and the corresponding communication link comprises an IP interface, VoIP signaling protocol, and real-time transport protocol (RTP) voice format. In another embodiment, the selected service provider equipment 130 comprises a CO, and the corresponding communication link comprises an E1 interface, V5.x signaling protocol, and PCM voice format. In another embodiment, the selected customer equipment 120 comprises a PBX, the selected service provider equipment 130 comprises a CO or a PBX, and the corresponding communication link comprises an E1 interface, MFC/R2 signaling protocol, and PCM voice format. Other exemplary embodiments will become apparent to those of ordinary skill in the art in view of the present disclosure. For example other common customer protocols include POTS, loop start, ground start, E&M, VoATM, Megaco, MGCP, H.323 and SIP. Moreover other common service provider protocols include V5.x, Megaco, MGCP, Q.931, QSIG, H.323, SIP, and MFC/R2.

In some cases, the gateway 110 forms communication links between customer equipment 120 with one associated signaling protocol and service provider equipment 130 with a different associated signaling protocol. In these cases, the gateway 110 typically must perform protocol conversions to create the appropriate communication links.

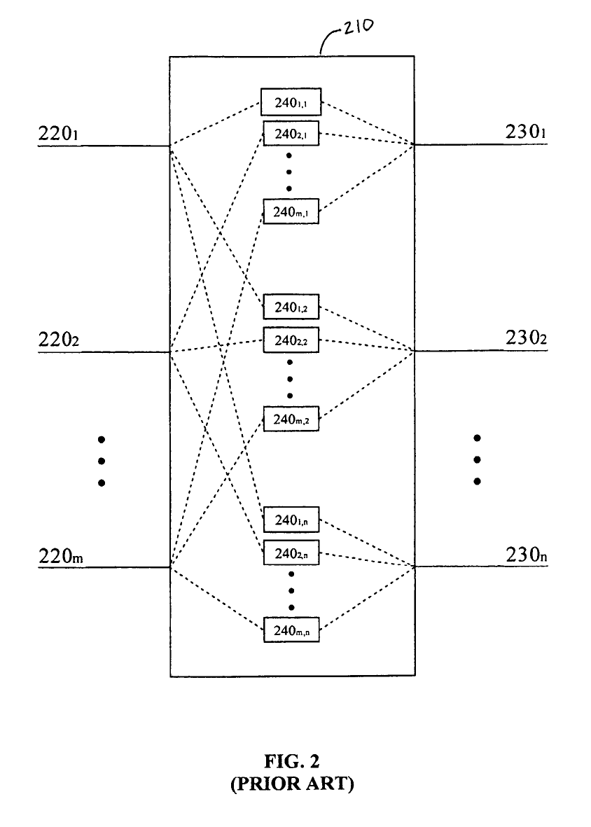

FIG. 2 illustrates a conventional gateway 210 capable of converting data and commands from one protocol to another using one traditional approach. As illustrated in FIG. 2, the gateway 210 is in communication with numerous customer equipment devices having m different customer protocols 220. The gateway 210 is also in communication with numerous service provider equipment devices having n different service provider protocols 230. The gateway 210 comprises a plurality of conversion modules 240, such as, for example, state machines, each of which is capable of performing a bilateral conversion between one customer protocol 220 and one service provider protocol 230. Because each conversion module 240 can only perform bilateral conversions, the gateway 210 must typically include a relatively large number (e.g., m×n) of conversion modules 240 to ensure that all of the necessary conversions for the supported protocols 220, 230 can be performed.

For example, in one specific illustrative embodiment, the gateway 210 supports customer equipment comprising POTS, VoATM terminals, and supports service provider equipment implementing the V5.x and media gateway control (Megaco) protocols. In this particular embodiment, the gateway 210 comprises a V5.x-to-POTS conversion module 240_{1,1}, a Megaco-to-POTS conversion module 240_{1,2}, a V5.x-to-VoATM conversion module 240_{2,1}, and a Megaco-to-VoATM conversion module 240_{2,2}. The following table summarizes the operation of each conversion module 240 when an incoming call is received.

TABLE 1

| Conversion Module | Input Signal | Output Signal |
|---|---|---|
| V5.x-to-POTS | ESTABLISH (L3 Address, | Ring on, Ring off |
| | cadenced ringing) | Ring on, Ring off |
| Megaco-to-POTS | ADD (Termination ID, | Ring on, Ring off |
| | ri-cad) | Ring on, Ring off |
| V5.x-to-VoATM | ESTABLISH (L3 Address, | Ring on, Ring off |
| | cadenced ringing) | |
| Megaco-to-VoATM | ADD (Termination ID, | Ring on, Ring off |
| | ri-cad) | |

This bilateral approach to the protocol conversion process presents a number of disadvantages. For example, using this approach, the gateway 210 is typically required to operate with different terminal identifier types, open separate conversion modules 240 (e.g., state machines) for each conversion type, and duplicate common operations, such as, for example, internal resource allocation, among the different processes. In addition, because management support is often based on dividing the gateway 210 into blocks according to protocols 220, 230 and implementing protocol-specific actions, support for protocol-independent, application-level operations is relatively difficult and non-intuitive.

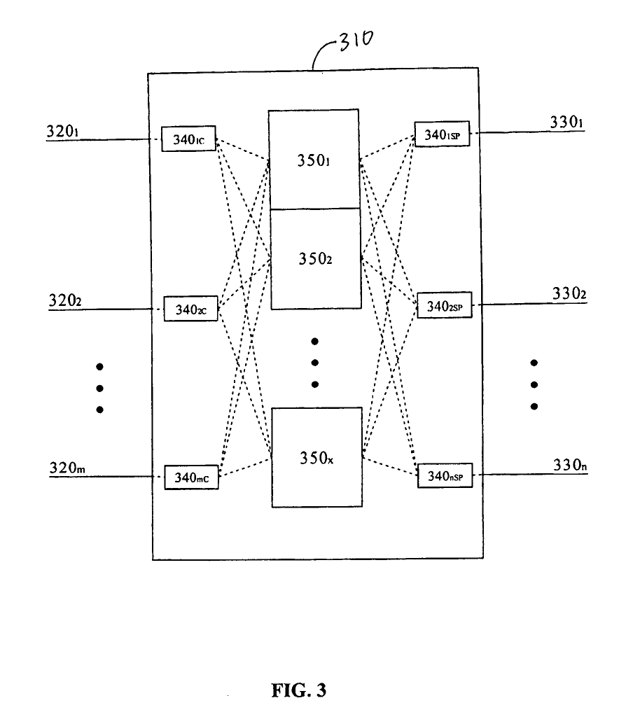

FIG. 3 illustrates a gateway 310 in accordance with one embodiment of the present invention. The gateway 310 is capable of converting data and commands from one protocol to another in a manner that overcomes many of the disadvantages identified above. Like the gateway 210 illustrated in FIG. 2, the gateway 310 illustrated in FIG. 3 is in communication with numerous customer equipment devices having m different customer protocols 320. The gateway 310 is also in communication with numerous service provider equipment devices having n different service provider protocols 330. Unlike the gateway 210 described above, however, the gateway 310 does not comprise a plurality of conversion modules 240 that perform bilateral conversions between two protocols. Rather, the gateway 310 comprises a series of protocol handlers 340 that map input signaling information from a specific protocol format to an abstract, protocol-independent information format. The protocol handlers 340 also convert information from the abstract information format to the protocol-specific format required by the output signaling protocol. By performing an intermediate conversion to an abstract information format, the gateway 310 advantageously needs only a relatively small number (e.g., m+n) of protocol handlers 340 for the supported protocols 320, 330, rather than the relatively large number of bilateral conversion modules 240 described above.

The gateway 310 also comprises a number of operation modules 350, such as, for example, state machines, that perform many common telecommunications operations using the data contained in the abstract information format. For example, one operation module 350 may handle incoming calls, whereas another operation module 350 may handle a management operation, such as, for example, service state management, active call clearing, or out of service report to EMS, to name a few.

In some embodiments, the abstract information format comprises a super-set of signaling information conveyed by all of the supported protocols 320, 330. Functionally equivalent information preferably appears only once in the abstract information format. For example, a pulse-dialed digit, a dual tone multi-frequency (DTMF) digit, or a digit extracted from a Q.931 message can all be represented in the same way (e.g., “digit n”) in the abstract information format. Moreover, a ringback tone and a Q.931 ALERTING message, which may both be applied on an ISDN line, can be represented in the same way (e.g., “far-end is alerting”) in the abstract information format.

The abstract information format also preferably comprises a series of generic management parameters which are abstractions of particular protocol concepts and can be used to perform many common management operations. For example, in some embodiments, the abstract information format comprises a mapping of physical addresses of analog lines, IP addresses of IP phones, behind-IAD terminal identifiers (characterized by an ATM connection and an identifier within the connection), and the like to unique values within a selected range of numbers. These values uniquely identify each subscriber, and can be used to perform management operations, such as, for example, service state management actions.

In some embodiments, each subscriber is identified on the network interface with a unique Terminal ID. This generic parameter preferably corresponds to a subscriber identifier in a variety of protocols, such as, for example, an L3 address in a V5.x protocol, an Endpoint ID in a media gateway control protocol (MGCP), a Termination ID in a Megaco/H.248 protocol, and the like. By providing unified handling of common management operations, such as, for example, configuration operations, the abstract information format advantageously provides a uniform view of the telecommunications system 100 and the served subscribers.

In one specific illustrative embodiment, the gateway 310 supports customer equipment comprising POTS, VoATM terminals, and supports service provider equipment implementing the V5.x and Megaco protocols. In this particular embodiment, the gateway 310 comprises a POTS handler 340_{1C}, a VoATM handler 340_{2C}, a V5.x handler 340_{1SP}, and a Megaco handler 340_{2SP}. The following tables summarize the operation of each handler 340 when an incoming call is received.

TABLE 2

| | | Output Signal |
|---|---|---|
| Handler | Input Signal | (To Basic Call Operation Module) |
| V5.x | ESTABLISH (L3 Address, | Incoming Call (Terminal ID, |
| | cadenced ringing) | cadenced ringing) |
| Megaco | ADD (Termination ID, | Incoming Call (Terminal ID, |
| | ri-cad) | cadenced ringing) |

As indicated in Table 2, when an incoming call having a V5.x protocol is received, the V5.x handler 340_{1SP} converts the ESTABLISH command to a generic Incoming Call command of the abstract information format, and passes this command to the basic call operation module 350₁. The V5.x handler 340_{1SP} also converts the L3 Address data to a generic Terminal ID, which is also passed to the basic call operation module 350₁, along with the cadenced ringing signal. In some embodiments, the mapping of the L3 Address to the Terminal ID is carried out by referencing a provisioning database within the gateway 310.

When an incoming call having a Megaco protocol is received, the Megaco handler 340_{2SP} converts the ADD command to a generic Incoming Call command of the abstract information format, and passes this command to the basic call operation module 350₁. The Megaco handler 340_{2SP} also converts the Termination ID data to a generic Terminal ID, which is also passed to the basic call operation module 350₁, along with the ri-cad signal. As discussed above, in some embodiments, the mapping of the Termination ID to the generic Terminal ID is carried out by referencing a provisioning database within the gateway 310.

TABLE 3

| | Input Signal | |
|---|---|---|
| Handler | (From Basic Call Operation Module) | Output Signal |
| POTS | Incoming Call (Terminal ID, | Ring on, Ring off |
| | cadenced ringing) | Ring on, Ring off |
| VoATM | Incoming Call (Terminal ID, | Ring on, Ring off |
| | cadenced ringing) | |

Once the input signal information has been mapped to the abstract information format, the information is converted from the abstract information format to the protocol-specific format required by the output signaling protocol, as indicated in Table 3. For example, if the incoming call is directed to a POTS terminal, then the POTS handler 340_{1C} converts the Incoming Call command, the Terminal ID signal, and the cadenced ringing signal to successive Ring on, Ring off commands at the appropriate POTS terminal. If the incoming call is directed to a VoATM terminal, then the ISDN handler 340_{2C} converts the Incoming Call command, the Terminal ID signal, and the cadenced ringing signal to a sequence to ring on, ring off commands at the appropriate terminal.

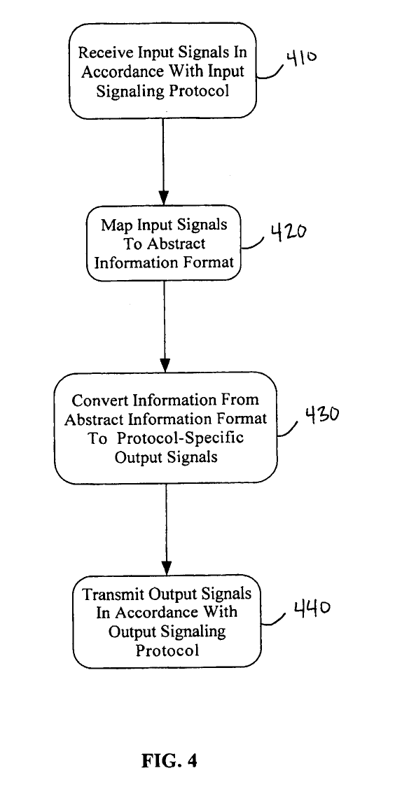

FIG. 4 is a flow chart illustrating the basic operation of the gateway 310 shown in FIG. 3. In a first step 410, input signals are received in accordance with an input signaling protocol. In a second step 420, the input signals are mapped into an abstract information format, as described above. In a next step 430, information from the abstract information format is converted to protocol-specific output signals in a format required by the output signaling protocol. In a final step 440, the output signals are transmitted in accordance with the output signaling protocol.

The protocol conversion process described above presents a number of distinct advantages over traditional approaches. For example, by performing an intermediate conversion to an abstract information format, the gateway 310 advantageously needs only a relatively small number (e.g., m+n) of protocol handlers 340 for the supported protocols 320, 330, rather than a relatively large number of bilateral conversion modules 240. In addition, by providing unified handling of common management operations, the gateway 310 advantageously provides a simplified, more intuitive interface for managing protocol-independent, application-level operations. These and other advantages will become apparent to those of ordinary skill in the art in view of the present disclosure.

Although this invention has been described in terms of certain preferred embodiments, other embodiments that are apparent to those of ordinary skill in the art, including embodiments that do not provide all of the features and advantages set forth herein, are also within the scope of this invention. Accordingly, the scope of the present invention is defined only by reference to the appended claims and equivalents thereof.

1. A method for converting telecommunications data from a first protocol to a second protocol, the method comprising:
receiving input signals in conformance with the first protocol;
mapping the input signals to an abstract, protocol-independent information format;
converting information from the abstract, protocol-independent information format to protocol-specific output signals; and
transmitting the output signals in conformance with the second protocol.

2. The method of claim 1, wherein the first protocol is selected from a group of protocols comprising V5.x, Megaco, MGCP, Q.931, QSIG, H.323, SIP, and MFC/R2.

3. The method of claim 1, wherein the second protocol is selected from a group of protocols comprising POTS, loop start, ground start, E&M, VoATM, Megaco, MGCP, H.323 and SIP.

4. The method of claim 1, wherein the abstract, protocol-independent information format comprises a super-set of signaling information contained in the first and second protocols.

5. The method of claim 1, wherein mapping the input signals is carried out by a first protocol handler.

6. The method of claim 1, wherein converting information is carried out by a second protocol handler.

7. The method of claim 1, wherein converting information comprises converting protocol-specific address information to a generic Terminal ID.

8. The method of claim 1, further comprising performing an operation using an operation module.

9. The method of claim 8, wherein the operation comprises a management operation.

10. The method of claim 1, wherein the input signals are received over one or more telecommunications networks.

11. The method of claim 10, wherein the telecommunications networks comprise an IP network or a PSTN network.

12. The method of claim 10, wherein the telecommunications networks comprise an IP network or a PSTN network.

13. The method of claim 1, wherein the output signals are transmitted over one or more telecommunications networks.

14. The method of claim 12, wherein the telecommunications networks comprise an IP network or a PSTN network.

15. A telecommunications gateway in communication with a plurality of costumer equipment devices having different customer protocols and with a plurality of service provider equipment devices having different service provider protocols, the telecommunications gateway comprising:
a plurality of protocol handlers, wherein each protocol handler is associated with a given customer protocol or service provider protocol; and
a plurality of operation modules in communication with each of the protocol handlers,
wherein each of the protocol handlers is configured to convert input signals in conformance with the associated protocol to a generic information format,
wherein each of the protocol handlers is further configured to convert information from the generic information format to output signals in conformance with the associated protocol, and
wherein each of the operation modules is configured to perform a telecommunications operation using information in the generic information format.

16. The telecommunications gateway of claim 15, wherein the service provider protocols are selected from a group of protocols comprising V5.x, Megaco, MGCP, Q.931, QSIG, VoATM, H.323, SIP and MFC/R2.

17. The telecommunications gateway of claim 15, wherein the customer protocols are selected from a group of protocols comprising POTS, loop start, ground start, E&M, VoATM, Megaco, MGCP, H.323 and SIP.

18. The telecommunications gateway of claim 15, wherein the generic information format comprises a super-set of signaling information contained in the protocols supported by the telecommunications gateway.

19. The telecommunications gateway of claim 15, wherein the operation modules comprise state machines.

20. The telecommunications gateway of claim 15, wherein converting information in conformance with an associated protocol to a generic information format comprises converting protocol-specific address information to a generic Terminal ID.

21. The telecommunications gateway of claim 15, wherein each operation module is configured to perform one or more management operations.

22. The telecommunications gateway of claim 15, wherein the telecommunication gateway is in communication with a plurality of service provider equipment devices over one or more telecommunications networks.

23. The telecommunications gateway of claim 22, wherein the telecommunications networks comprise an IP network and/or a PSTN network.

24. A machine readable medium comprising machine readable instructions for causing a computer to perform a method comprising:
receiving input signals in conformance with a first protocol;
mapping the input signals to an abstract information format;
converting information from the abstract information format to protocol-specific output signals; and
transmitting the output signals in conformance with a second protocol.

25. The machine readable medium of claim 24, wherein the first protocol is selected from a group of protocols comprising V5.x, Megaco, MGCP, Q.931, QSIG, VoATM, H.323, SIP and MFC/R2.

26. The machine readable medium of claim 24, wherein the second protocol is selected from a group of protocols comprising POTS, loop start, ground start, E&M, VoATM, Megaco, MGCP, H323 and SIP.

27. The machine readable medium of claim 24, wherein the abstract information format comprises a super-set of signaling information contained in the first and second protocols.

28. The machine readable medium of claim 24, wherein mapping the input signals is carried out by a first protocol handler.

29. The machine readable medium of claim 24, wherein converting information is carried out by a second protocol handler.

30. The machine readable medium of claim 24, wherein converting information comprises converting protocol-specific address information to a generic Terminal ID.

31. The machine readable medium of claim 24, further comprising causing the computer to perform an operation using an operation module.

32. The machine readable medium of claim 31, wherein the operation comprises a management operation.

33. The machine readable medium of claim 24, wherein the input signals are received over one or more telecommunications networks.

34. The machine readable medium of claim 33, wherein the telecommunications networks comprise an IP network or a PSTN networks.

35. The machine readable medium of claim 24, wherein the output signals are transmitted over one or more telecommunications networks.

36. The machine readable medium of claim 35, wherein the telecommunications networks comprise an IP network or a PSTN network.
